(19) United States
(12) Patent Application Publication
(10) Pub. No.: US 2017/0067934 A1
(43) Pub. Date: Mar. 9, 2017

(54) SNOM SYSTEM WITH LASER-DRIVEN PLASMA SOURCE

(71) Applicants: Xiaoji Xu, Bethlehem, PA (US); Martin Wagner, Santa Barbara, CA (US)

(72) Inventors: Xiaoji Xu, Bethlehem, PA (US); Martin Wagner, Santa Barbara, CA (US)

(21) Appl. No.: 15/256,294

(22) Filed: Sep. 2, 2016

Related U.S. Application Data
(60) Provisional application No. 62/215,324, filed on Sep. 8, 2015.

(51) Int. Cl. G01Q 60/06

(52) U.S. Cl. CPC G01Q 60/06

(57) ABSTRACT

An s-SNOM near-field system containing an interferometer and configured to utilize IR-light output from a laser-driven plasma source of light. The system is equipped with (i) spectral and/or spatial filter(s) chosen to dimension the image of the plasma source formed at the tip of the system be substantially co-extensive with the tip, and/or (ii) an optical-inspection unit, located outside and not being part of the interferometer, that is structured to ensure that plasma source is imaged onto the tip of the system without astigmatism. The plasma-containing component(s) of the plasma source is/are engineered to have IR-light-output maximized in mid-IR range.

### CROSS-REFERENCE TO RELATED APPLICATIONS

The present application claims priority from and benefit of a U.S. Provisional Patent Application No. 62/215,324 filed on Sep. 8, 2015, entitled “An SNOM system with laser-driven plasma source”, the disclosure of which is incorporated herein by reference.

### TECHNICAL FIELD

The present invention relates to apertureless or scattering-type scanning near-field optical microscopy (s-SNOM) and, in particular, to a s-SNOM/AFM system employing a laser-driven plasma source as a source of light illuminating a probe thereof and a method for optimization of the optical alignment of the system.

### BACKGROUND

The current use of various laser sources (broadband, narrow band, spectrally tunable, for example) in infrared (IR) spectroscopic applications, while operationally convenient, comes at a hefty price of several hundred thousand dollars. Cost of a typical s-SNOM system, when equipped with one of such sources, is at least doubled. The use of a specialized white-light source such as a Globar, for example, while seemingly convenient, begs a question of whether the power output from the source, required by the s-SNOM system in the spectral region of interest (such as the mid-IR region, for example), is sufficient—and the practical answer to this question remains not necessarily satisfactory. Aside from the issue of insufficiency of the useful light output, the degree of spatial coherence of light produced by the Globar thermal light source is very low as compared to that of laser sources, which results in poor interference signals (that form the basis for IR s-SNOM spectroscopy). The need remains, therefore, in a near-field scanning optical microscopy system configured to generate operably-sufficient optical power in the mid-IR region of spectrum and deliver it to the tip of the near-field system while optimizing the focal spot at the tip of the system and without producing the above-the-operational-threshold amount of background optical contribution at the optical detection unit of the system.

### SUMMARY

Embodiments of the invention provide a near-field system that includes a laser-driven plasma source of light, configured to generate a first light output (such that the first light output contains IR light and has a first range of spatial frequencies and a first range of spectral frequencies); a first optical system located to collect the light output at least along the axis and to form a second light output (such that the second light output has a second range of spatial frequencies and a second range of spectral frequencies), where the first and second ranges of spatial frequencies are different form one another. The near field system additionally includes an optical interferometer system with a reference arm and a sample arm and in optical communication with the plasma source of light through the first optical system. The sample arm terminated by a reflector structured as a tip of the near-filed system; the system is configured to provide for relative movement between the tip and the sample under test (optionally—in a reiterative fashion) during the operation of the near field system. The system further includes an optical detection system disposed in optical communication with s reflector through the optical interferometer system and in optical communication with the reference arm to acquire an optical signal interferometrically formed by first light (backscattered by the reflector in response to being illuminated with a portion of the second light output, and second light (which second light represents a portion of the first light output that is phase-delayed with respect to the first light. The near-field system may include an off-axis light-focusing optical element disposed to focus light, arrived to such optical element through the sample arm of the interferometer, onto the reflector without adding astigmatism caused by the off-axis light-focusing optical element.

Embodiments of the invention provide for a method of alignment or adjustment of the above near-field system. The method includes reflecting a tip-targeting beam of light (which contains spatially-overlapped beams of IR and visible light and which has interacted with an off-axis light-focusing optical element disposed in a sample arm of an interferometer unit of the near-field system) in a focal plane (for example, at a focal spot) of the off-axis light-focusing optical element to form a return optically-diffused beam of light and to propagate the return optically-diffused beam of light through the sample arm towards the first beamsplitter. The method may further include adjusting at least one of orientation and position of the off-axis optical element to define an image of the focal spot (the image being formed in light of the return optically-diffused beam of light that has propagated through said sample arm) until such image is indicative of absence of astigmatism caused by at least one of orientation and position of the off-axis optical element.

In one situation, the tip-targeting beam of light is that produced by the radiant output from the laser-driven plasma source. In a specific embodiment, the method may further include a step of formation of the tip-targeting beam of light by overlapping a first beam of infrared (IR) light output, produced by a laser-driven plasma source of light, with a second beam of visible light, produced by an external light source, with the use of a first dichroic beamsplitter.

Embodiments of the invention also provide for a method of alignment or adjustment of the overlap of the IR light beam with the active element, the tip, in the above near-field system. The method overlaps the IR beam with the tip by the visible beam collinearly emitted from the plasma-driven laser source.

### BRIEF DESCRIPTION OF THE DRAWINGS

The invention will be more fully understood by referring to the following Detailed Description of Specific Embodiments in conjunction with the not-to scale Drawings, of which:

FIG. 1 is a schematic diagram of an embodiment of the invention;

FIGS. 2A, 2B are diagrams illustrating differently configured versions of a laser-drive light source;

FIG. 3 is a diagram illustrating an embodiment configured to facilitate the pointed irradiation of a tip of the SNOM system with IR light generated by the plasma source of the invention;

FIGS. 4A, 4B, 4C, and 4D are diagrams illustrating related embodiments of the laser-pumped plasma-based light source for use with the system of the invention;

FIG. 5 is a diagram illustrating a portion of a related embodiment of the invention.

Generally, the sizes and relative scales of elements in Drawings may be set to be different from actual ones to appropriately facilitate simplicity, clarity, and understanding of the Drawings. For the same reason, not all elements present in one Drawing may necessarily be shown in another.

### DETAILED DESCRIPTION

The implementation of the idea of the invention stems from the recognition of a need to increase the amount of power output, delivered from the light source of choice to the tip of an s-SNOM system in the particular spectral region of interest.

In scattering scanning near-field optical microscopy (s-SNOM), a polarizable tip of an atomic force microscope (AFM) is brought in close proximity to the sample of interest (sample under test, or SUT). When the tip-sample region is illuminated with light (such as IR light at the wavelength of interest), the tip of the system acts as an antenna and concentrates the electromagnetic energy to a region of enhanced electric near-field(s) under the tip. The near-by presence of the sample of interest modifies such evanescent fields in a fashion that depends on the sample's dielectric constants. The tip reradiates the so-modified near-fields, acting as a reflector of IR light incident upon it, into far-field radiation that now is different in amplitude and phase as compared to the incident light. The dependence of the back-scattered light on the sample's local, complex dielectric properties allows the user of the system to identify the material of the SUT under the tip by determining these complex valued quantities based on the behavioral response of the s-SNOM system. The spatial resolution of the material-properties determination is given, in the first order, by the tip radius of typically 2 nanometers to about 100 nanometers and is, therefore, by 2 to 3 orders of magnitude better than the diffraction-limited resolution achieved by standard far-field optical techniques (such as Fourier-Transform IR, FTIR, spectroscopy, for example).

When the s-SNOM methodology is employed, detection of the weak back-scattered by the tip light in both amplitude and phase is usually achieved as a result of the interferometric amplification of the tip-scattered light with a stronger reference field that is usually directly derived from the incident light beam. To effectuate such amplification, the light beam entering the s-SNOM system is typically separated in a Michelson-type interferometer of the system into a sample beam and a reference beam (which are appropriately directed through the sample and reference arms of the interferometer), and a portion of such light-beam is directed through the interferometer towards the tip of the s-SNOM system. The return signal provided by the portion of the incident light beam back-scattered at the tip and containing sought-after near-field information is weak as compared to that representing background-scattered light (interchangeably referred to herein as a background scatter or background scattering, or background contamination). The background scatter originated from illumination of the cantilever of the tip, the tip itself, and the sample of interest and is caused, at least in part, by the fact that the spot of the illuminating radiation delivered to the tip-region of the s-SNOM system spot is usually larger than the tip itself.

A common method to minimize the background contamination of the useful back-scattered near-field-information-containing signal originating from the tip is to introduce a relative motion between the tip and the SUT, for example, to move the tip in and out of contact with the SUT (or vice versa). This way, the tip-back-scattered light contains near-field information when the tip is close to the sample (within typically 50 nm or so) as compared to the case where the tip is further away (when the exponentially-decaying evanescent near-fields associated with the tip cannot be efficiently coupled with the SUT anymore). Comparison of the scattered light signals obtained when the tip is in and out of contact with the SUT allows the user to subtract the background contamination from the sought-after tip-scattered signal to obtain the sought-after near-field information. In one example, the tip can be oscillated periodically at or near the tip's resonance frequency in a so-called tapping mode. A lock-in amplifier unit of the s-SNOM system then is used to extract the near-field contribution, to the return signal, at higher harmonics of the tip oscillation frequency. While the first harmonic of the return signal is stronger than those at higher harmonics and contains mostly background light that does not reveal the localized properties of the SUT, portions of the return signal at higher harmonics such as the second or third harmonic may be used to measure the near-field with stronger background suppression.

Known light sources operably coupled to or equipping s-SNOM systems to operate in the infrared portions of the spectrum include (i) laser sources such as, for example, a quantum cascade laser, a CO₂ laser, a fiber-laser—such as that based on difference-frequency generation, or an optical parametric oscillator, which are characterized by a narrow-band spectral coverage, and (ii) a synchrotron, a Globar, and a high-temperature Argon-arc source (HTAAS). While laser sources typically provide sufficient power for operation of the s-SNOM system, such sources cover only a limited spectral range and are typically quite costly. While synchrotrons cover a broader spectral range, including the 2 micron to 5 micron range not easily accessible by lasers, such sources are large user-facilities and very expensive to maintain and operate. Globars on the other hand are thermal emitters with black-body temperatures of about 1500 K, covering a broad spectrum of wavelengths from the visible portion of the spectrum to the infrared portion of the spectrum via the Planck radiation law. The typical Globar source of light is inexpensive, but its performance in conjunction with an s-SNOM is extremely poor due to low levels of brilliance and incoherent radiation output. An HTAAS is a plasma source, in which an electrically-maintained discharge in a noble gas (such as, for example, Argon) plasma kept at close-to-atmospheric pressure is used to provide thermal radiation of a plasma at a temperature of about 10,000 K. The associated higher temperature results in increased brilliance of an HTAAS as compared to a Globar source. However, as evidenced by the body of literature in related art, HTAASs have not found wide application in s-SNOM operation, although HTAASs appear suited for (far-field) radiometric applications and (far-field) FTIR spectroscopy that require a high degree of intensity stability. The recognized disadvantages of HTAASs as sources of radiation include fairly high complexity and cost, as well as high input-power requirements (in the tens of kW range, with the use of currents of about 100 Amperes). The current between the electrodes of an HTAAS results in gradual degradation of the electrodes due to sputtering. s-SNOM systems equipped with HTAASs were not observed or successfully utilized to demonstrate spectroscopy for material identification (such as, for example, investigating weakly absorbing polymers), but instead were only used on materials with a strong s-SNOM response (such as finding strong probe or antenna resonances).

Either a HTAAS or a Globar source is not a point-like emitter, but has an extended, several square-millimeter surface area. The large area can be easily imaged on the detector in a (far-field) FTIR spectroscopy instrument and typically provides enough power to saturate an IR detector (usually chosen to be an liquid nitrogen cooled mercury cadmium telluride, or MCT, detector). But in an s-SNOM application, the near-field signal of interest, backscattered from the active element (the tip) of the SNOM apparatus, is small due to the small physical dimensions of the tip itself (of about 10 to 20 microns) and due to the very small interaction, spatial volume under the tip that is typically is no larger in size than about 50×50×50 nm³. The practical challenge, therefore, remains to efficiently illuminate the tip with highest intensity light by locating light output from the chosen light source at the tip with a spot size comparable to or smaller than the size of the tip itself. This spot-size requirement and the numerical aperture (NA) of the light-focusing element of the s-SNOM system determine, in practice, the s-SNOM etendue of (NA times the spot-size).

The maximum accepted source etendue is the same and hence limits the source NA for a given source size, or vice versa. Globar light sources have quite large surface areas (1,000 to 10,000 times larger than the size of the tip, which inevitably limit the useful NA of the Globar source to very small values and/or solid angles so small that, for practical purposes, the power remitted by a Globar source within such small solid angles is simply insufficient for s-SNOM operation due to the lower brilliance of the Globar source. While a typical HTAAS source has higher brilliance, it has still not proven useful for s-SNOM applications, likely due to instability of the plasma position in the source that causes the movements of a focal spot, formed by the optical system of the s-SNOM, over the tip and thus causes non-stationary operation. A small point-like source of high brilliance and position stability is desired for implementation of a high-NA light source used as a light source in an s-SNOM system.

A problem of insufficient level of illumination of the tip of an s-SNOM system with light at wavelengths of interest (including the wavelengths within the range from about 2 microns to about 5 microns) with the use of conventional sources of light has been solved by equipping an s-SNOM system with a laser-driven plasma-based source of light that has been judiciously modified a) to increase the optical power output from such source of light at the wavelengths of interest as compared to the unmodified source and/or b) spatially-separate the first and second portions of the clear aperture of such source through which the plasma emitter of the source is pumped by the pump laser and the optical power output is collected, respectively.

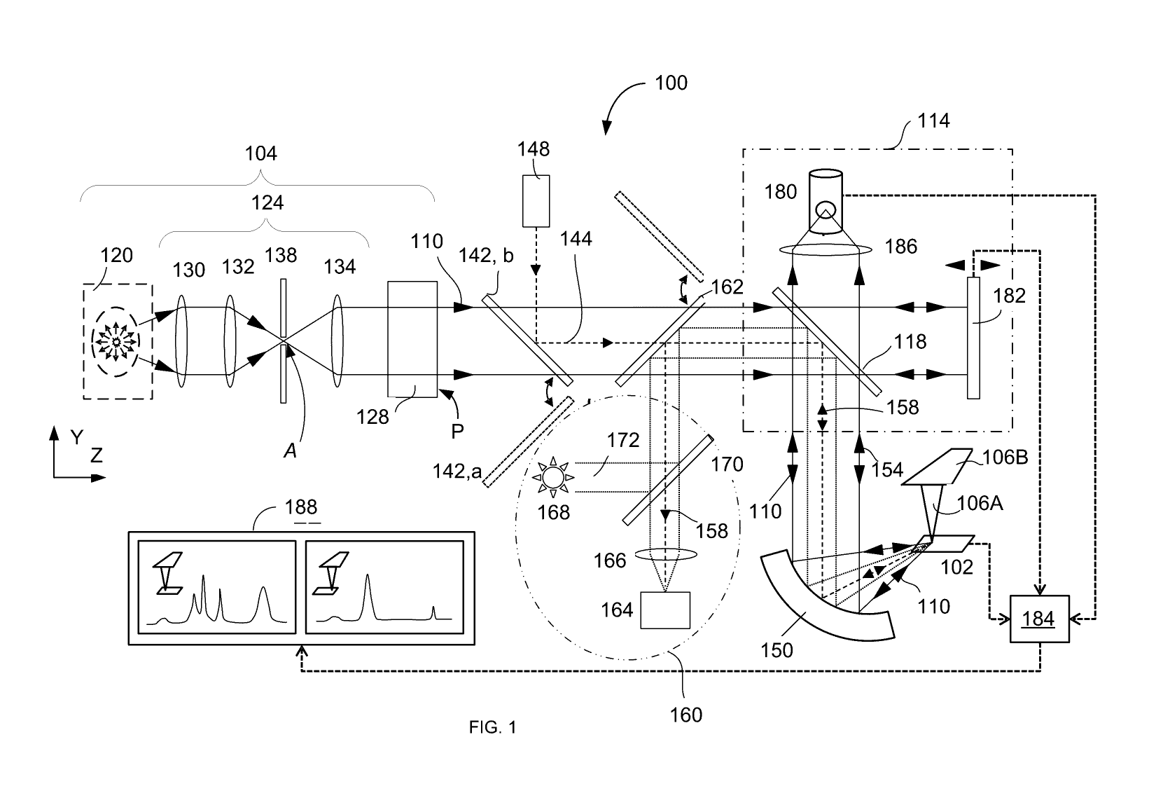

An implementation of an s-SNOM system according to the idea of the invention is schematically presented in FIG. 1. Here, an s-SNOM system 100 is illustrated configured for interrogation of a sample 102 with the use of an atomic-force microscope (a tip 106A of which is shown on a cantilever 106B). The system 100 combines a light-source portion 104, judiciously configured to provide IR light 110 for illumination of the tip 106A, with an optical interferometer 114 (outlined with a dot-dashed line), in reflection from a beamsplitter 118 of which light 110 is directed towards the apex of the tip 106A.

Light Source Portion of the System.

The light source portion 104 includes a source of light 120, a spatial filter system 124, and an optional (used in one specific implementation) spectral filter system 128, that aggregately purify the light distribution reaching the s-SNOM system from the source 120 both spectrally and spatially to produce, at the output (schematically indicated as P) of the light source portion 104, a monochromatic, substantially collimated beam 110 (characterized, preferably, by a full angle of divergence or convergence not exceeding 5 degrees; more preferably—not exceeding 2 degrees; and even more preferably—not exceeding 1 degree). As discussed in more details below, the spectral filter component 128 can be combined, integrated with, affixed to or made part of the source 120.

The spatial filter system 124 (a non-limiting example of which, as shown, includes lenses 130, 132, and 134) is configured to initially form an optical image A, (as schematically indicated by the intersection of beams exiting the lens 132) of the source 120 at the intermediate image plane (perpendicular to the plane of the drawing; xy-plane, as shown), thereby defining the light distribution A and the spatial distribution of light at the source 120 to be optically conjugate to one another. At the location of the intermediate image A (or, more generally, in the vicinity of such location, for example within a range of +/−10 percent of the value of the distance between lens 132 and the intermediate image plane), a filter component 138 is disposed to introduce at least one of the following changes to the light distribution of the intermediate image A:

a) Re-definition of the spatial boundaries of such light distribution and/or its shape in the intermediate image plane. (Such re-definition facilitates the solution to the problem that may arise as a result of the process of imaging of the spatially-extended emitter of light of the source 120 onto the tip of the s-SNOM system, when a portion of light may be imaged outside of the tip if the imaging optics are not well matched. In case of such mismatching, a zone of background is formed, around and outside of the tip 106A, that is lit with signal light and that reduces the signal-to-noise ratio during the operation of the system. Specific embodiments configured to facilitate the solution to such problems are further addressed below.) It is appreciated that configuring the optics of the s-SNOM system to reduce the dimensions of spatial light distribution to only that size comparable with the dimensions of the tip also reduces the spotsize of the ‘reference’ light, i.e. the portion of light that is reflected off the interferometer mirror 182 and focused on the detector 180. The reference light signal is stronger than the tip-scattered, near-field light signal with which the reference portion of light interferes on the detector. To achieve the optimized signal-to-noise ratio, both the sample light portion (that one incident on and scattered and returned to the detector 180 by the tip 106A of the system) and the reference light portion (the one returned to the detector 180 by the reflector 182) are shaped to have substantially the same spatial size via the proposed re-definition of the spatial boundaries of the light distribution in the intermediate image plane.

b) Modification of the spectrum of spatial frequencies of such light distribution (by, for example, blocking the predefined spatial-frequency components such as components above a predefined cut-off frequency or, in a different example, components with frequencies below a predefined cut-off, from propagating beyond the filter 138); and

c) spatially-dependent apodization of intensity and/or spatial frequency and/or spectral frequency and/or polarization distribution of light across the intermediate image plane. It is understood that, generally, the component 138 is configured to increase the degree of spatial coherency of light passed on towards the collimating lens 134 while, at the same time, blocking from propagation down the optical axis the radiation produced by the (hot) bulb or otherwise defined optically-transparent housing of the source 120 and/or spurious reflections of light within such housing.

Further, light from the so-modified by the spatial filter 138 light distribution at the intermediate image plane is received by the constituent lens 134, positioned coaxially with both lenses 130, 132 such that its focal point is located at the image A, to form a collimated beam exiting the lens 134 towards the (optional) spectral filter system 128.

In one non-limiting example, the portion 104 includes a laser-driven (laser pumped) plasma light source 120 complemented with a train 124 of judiciously-defined spectrally and/or spatially beam-shaping optical components.

(A) In present implementations, a laser-driven (laser pumped) plasma light source 120, is advantageously configured in contradistinction with a conventional configuration of a plasma light source discussed, for example, in U.S. Pat. No. 8,242,695 and/or U.S. Pat. No. 8,525,138 (the disclosure of each of which is incorporated herein by reference).

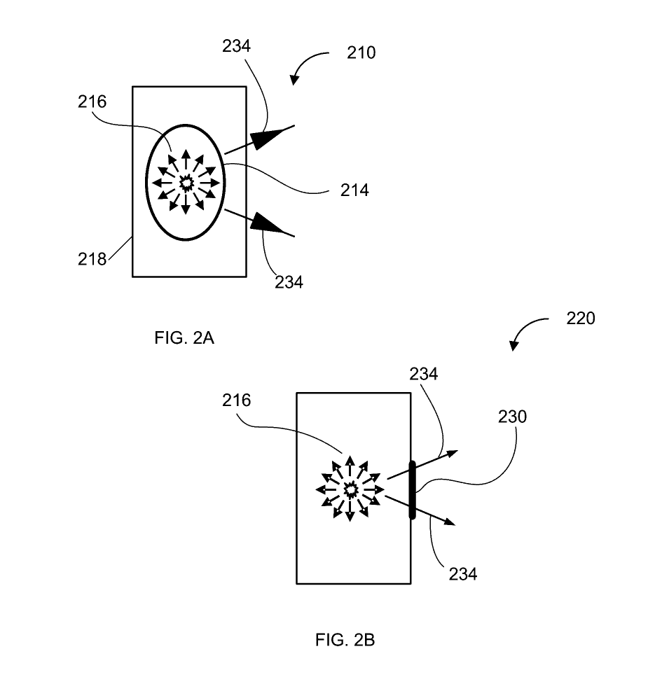

A conventional plasma source 210, schematically shown in FIG. 2A is housed in a quartz bulb 214 operationally-required to ensure high pressure that is needed to maintain the gas and the plasma 216 inside, and then in an outer housing structure 218. Quartz or fused silica is not transmissive in the mid-IR region above about 3.5 microns and simply cannot provide the user with operational access to light in the fingerprint spectral region from about 2 microns to about 12 microns, which is required for chemical material identification.

A discharge between the electrodes of the source 210 (not shown) excites a noble gas (here, Xe), filling a glass bulb at a pressure of about 30 bar. A laser pump source (not shown) tuned to at least one of absorption line of the excited noble gas to transfer energy to the gas and to maintain plasma confined around the focus of the laser beam, creating a small hot (≧10,000K) plasma source with spatial dimensions of about 60 microns by 140 microns (FWHM) which, as a thermal source, emits radiation in the UV spectral region, visible spectral region, and IR spectral region. The overall power emitted in the solid angle 4π steradian is about 1 W. Due to the conventional design of the source 120, the useful output in the NIR and IR portions of the spectrum (as measured in transmission through the Si filter, defining a long-pass filter with the cut-off wavelength at about 1.1 micron) is limited by the numerical aperture of about 0.47 and a non-transparent to IR-radiation housing to about 10 mW (in one case—to about 6 mW). Alternatively, other semiconductor-material based filters (e.g., Ge) can be used to tailor the spectrum of the output from the source 120. The power density per unit surface area (that is, the irradiance of the output) is, therefore, about 10 to 50 times larger than that for a conventional Globar source (e.g. SiC).

In reference to FIG. 2B, an embodiment 220 of the light source 120 of the present invention is illustrated schematically, in which the element 230 denotes an optical window through which light generated by the light source is delivered (as schematically and not to scale shown with arrows 234) to the ambient medium surrounding the source 220. Notably, in the embodiment, the container/bulb 214 is preferably removed (or, optionally substituted with a version including the window 230 incorporated into the wall of the bub 214, not shown) while the outer housing structure 218 is appropriately re-structured to provide for high-internal pressure operation of the source 220.

Different materials such as Silicon, Magnesium Fluoride or Calcium Fluoride offer a wider transparency range up to about 8 microns (or higher to about 12 microns for Barium Fluoride). The FTIR window 230 for the mid-IR region can also be made from Germanium, KRS-5, Zinc Selenide. The use of diamond for an FTIR window 230 could be beneficial due diamond's large transparency range in the infrared and its excellent mechanical stability. The large fracture strength allows to minimize the window thickness by 4× compared to that of ZnSe (which is a typical IR material used for such purposes). At the same time, the smaller thickness of an optical window in a laser-driven plasma source reduces IR absorption. IR absorption can occur at Nitrogen defects which are common in CVD diamond and whose absorption lines lie around 5 microns, i.e. in the center of the IR fingerprint region. A person of skill in the art would appreciate from the above discussion, therefore, that it may be preferred to minimize the Nitrogen content in the diamond window of the light source. The window 230 is located next to an approximately 10,000 K hot plasma and tens of Watts of pump light (not shown) are delivered from the driving laser (not shown) into the cell. In one embodiment, the pump laser light leaves the cell through the IR window, which makes it operationally more complex since the strong pump light needs to be filtered out from the weak IR light signal of interest. In addition the IR window material may absorb parts of the strong pump light, causing the generally undesired local heating of the window. In another embodiment the pump light may be extracted from the cell through another window that is transparent to the pump light. The operationally simplest approach is to dump the pump light into the inner wall of the cell, where it is absorbed or diffusely scattered, heating up the cell. Under these conditions (where the cell can be heated above room temperature, e.g. to 100 degrees C.), it is preferred that the material from which the window of the cell is constructed has a high thermal conductivity. High thermal conductivity results in efficient thermal equilibration and minimizing of a heat gradient between center of the window and edge which could lead for instance to mechanical stress and damage. A low coefficient of thermal expansion as observed in diamond, for example, is again beneficial to minimize those effects. It helps further to maintain the cell sealed while the temperature varies when the plasma source is switched on/off. A low thermal expansion also helps to keep the window shape constant and prevent the formation of a thermal lens, i.e. where the window material could locally change its thickness due to high local temperature (e.g. in the window center close to the plasma) which can compromise the image quality through the window. A further benefit compared to some materials such a Ge or Si is the optical transparency. It allows to align the s-SNOM instrument to the visible output of the plasma thermal emission. While natural diamond may be preferred, CVD diamond material is readily available and has similar properties at lower costs.

Polycrystalline windows are inexpensive compared to single-crystal ones, but typically show grain sizes in the 10 micron to 100 micron ranges. These grains scatter the IR light and distort the wave fronts emitted by the point-like plasma source within the housing where the diamond window serves as exit for the IR radiation. Another negative effect of grains is that the plasma appears smeared out and larger when imaged through a grainy polycrystalline window. The thus-negatively influenced IR light cannot be focused as tightly onto the s-SNOM tip as an undisturbed beam could and it cannot interfere as efficiently in the s-SNOM spectrometer. IR power in the beam 234 is also substantially lost by scattering at these grains. Hence, single crystal diamond windows 230 are preferred in the implementation of the embodiment of the invention to reduce light scattering and spatial distortion of a useful wavefront at the operational wavelengths within the fingerprint spectral region of the output 234. It is appreciated, therefore, that in one embodiment the spectral window 230 is configured as a spectral filter facilitating spectral purification of the light output P and, in such embodiment, may substitute or, alternatively, be used in conjunction with the spectral filter 128 of FIG. 1.

In one implementation, the casing of the plasma source may be electrically grounded to prevent interference/noise, at radio-frequencies, due to radiation of other electronic devices including the drive circuit of the atomic force microscope tip. (Background noise due to coupling to the ion motions of the laser generated plasma, therefore, is prevented).

In a related implementation, the radiant output of the plasma source is monitored in terms of power and/or the plasma position is monitored in the visible portion of the spectrum (e.g. via a CCD camera). The power output and/or the spatial position of the plasma emitter itself is maintained constant via an electronic feedback loop. Power stabilization effect is achieved by adjusting the power and/or wavelength of the pump laser and/or the gas pressure in the light source. Plasma position stability is achieved by adjusting the pump laser focus position with respect to the light collection optics of the s-SNOM system. The operational goal of such operational arrangements is to minimize noise in the s-SNOM measurement (that otherwise can originate from unstable emission of the plasma and/or an unstable plasma position, translating into an unstable location of the image of the plasma emitter on the tip 106A).

(B) In further reference to FIG. 1, lens 130 of the optical train 124 is positioned in optical communication with the source 120 such as to collect radiation emitted by the source 120 and to guide a portion of this radiation containing at least IR light (and, in one specific case, also a visible light) towards the lens 132. Generally, the beam after lens 130 can be diverging, converging or be collimated whichever allows to collect the most light emitted by the source 120. As shown, a substantially collimated beam of light is directed towards the lens 132. In one implementation, lens 130 is a plano-convex lens with a focal length of about f₁₃₀=40 mm, made of an IR-transparent material (such as, for example, CaF₂) and is appropriately AR-coated to ensure low reflection losses. (In a related implementation, element 130 is an off-axis parabolic mirror with a focal length of f₁₃₀=100 mm or 150 mm.) Lens 132, forming the intermediate image A, has similar optical characteristics and is, in one case, a plano-convex CaF₂ with a focal length of f₁₃₂=50 mm (in a related implementation, lens 132 may be substituted with an off-axis parabolic mirror of f₁₃₂=25 mm or 100 mm, for example). It is appreciated that the combination of lenses 130, 132 can be replaced by other imaging system(s) including but not limited to, for example, aspheric lenses, achromatic lenses, spherical mirrors and/or (on- or off-axis) parabolic mirrors to reduce spectral dispersion and to improve quality of imaging of the source 120 onto the intermediate image plane. The combination of elements 130, 132, 138 is generally configured to provide the highest degree of spatial coherence of light emanating from the element 138 and the highest possible power density at or near the intermediate image location, (while at the same time blocking light that does not come from point-like light source 120, but is generated, instead, by the hot plasma-containing bulb; or resulting from spurious reflections of radiation produced by the source 120 within or at the housing of the source 120).

Notably, there may exist a tradeoff between involved focal lengths for optimal focusing on the pinhole, pinhole-size and optimization of the signal-to-noise ratio, SNR, of the near-field spectra collected by the system. For example, stronger, steeper focusing on the pinhole 138 via a short focal lens 132 reduces the image size of the plasma on the pinhole 138 if the collection lens focal lens 130 is kept constant. Consequently, more light is transmitted through the pinhole, including the spatially non-coherent portions of the light that does not interfere in the near-field interferometer that is described below. But this additionally transmitted light increases noise on the detector while it does not improve the S/N of the near-field interferogram and spectrum. In this situation a smaller pinhole 138 will block again the spatially non-coherent portions of the light which reduces the noise on the detector resulting in better near-field interferograms and spectra in terms of S/N. However, smaller pinholes also reduce the transmitted overall power which reduces the detector signal and hence decreases the S/N. An optimum needs to be found, where the transmitted power is maximum but where the transmitted light shows high spatial coherence.

C) The spatial filter component 138 may include a metallic (for example, stainless steel) circular pinhole with a diameter between about 10 microns and about 150 microns. In related embodiments, the pinhole can be replaced with an optical fiber; with an elliptical pinhole or with a rectangular one for instance comprised of a vertical and horizontal slit. The shape of the spatial filter is imaged onto the scattering tip 106. In order to reduce illumination of other parts than the tip itself (the tip is the active element in scattering SNOM) the shape of the spatial filter can be closer matched to the elongated tip shape that is typically shaped like a 5-to-20 micron long pyramid. In this case an elongated, rectangular or even pyramid-like shaped pinhole is preferred over a circular pinhole.

D) In one implementation, lens 134 is configured as an f₁₃₄=100 mm CaF₂ lens. (In a related implementation, the element 134 is configured as an f₁₃₄=25 mm or 50 mm parabolic mirror). The purpose of the lens is to provide a collimated beam and to image the pinhole onto the tip via the focusing element 150 with a magnification ratio given by the ratio between the focal lengths of element 150 to the one of element 134. The optimal combination of focal lengths for element 134 and element 150 allows to match the pinhole image with the tip height of typically 5-20 um.

E) The optional spectral filter system 128 may be configured as a monochromator instrument, as either a diffraction-grating based or a dispersion based system (for example, the monochromator instrument utilizing an optical prism). The filter system may also include a narrowband, bandpass, thin film interference filter. In a related embodiment, the spectral filter system can be appropriately integrated with the source 120 to modify the spectral content of light emitted by the plasma of the source upon emanation of such light towards the lens 130.

It is appreciated, therefore, that a combination of the first and second optical systems is configured to form an image, of a plasma distribution of said plasma source of light, at a tip of an atomic force microscope (AFM) of the system, said image being substantially co-extensive with said tip. In a related implementation, the spatial filter system 124 and/or the (optional) spectral filter system 128 can be separately placed in either or both arms of the interferometer 114, or, alternatively, directly in front of the detector 180 (i.e. between the beamsplitter 118 and detector 180). For instance, positioning of the element 124 from after the source 120 into the sample arm between beamsplitter 118 and focusing element 150 can be used to fulfill the same operational purpose of matching the IR spotsize on the tip 106A with the size of the tip. As a result of position of the (optional) spectral filter system 128 in the same sample arm of the interferometer (as opposed to the positioning shown in FIG. 1), for instance, results in transmission of light towards the tip at only a discrete spectral frequency and interference of such light, returned to the detector 180 only with light of the same frequency returned from the reference arm (despite the fact that the reference arm does not contain a spectral filter 128). Similarly, the spatial filter system 124 and/or filter 128 can be placed only in the reference arm of the interferometer 114 between the beamsplitter 118 and mirror 182.

Optional Beam Cooperation Arrangements for Alignment and Optical Inspection Unit.

Referring again to FIG. 1, the light output 110 from the light source portion 104 is further directed to the interferometer system 114 (in a specific example as shown—a Michelson-type interferometer, which example is not limiting; discussed below). On its path to the interferometer 114, the light output 110 is optionally co-axially combined (via a reorientable between positions a and b beamsplitter/beamcombiner 142) with a beam 144 of visible light, produced for example by a HeNe (or a semiconductor) laser 148. Optical path of the visible beam is used to represent and trace the optical path of the IR portion of the beam 110 upon the propagation between the beamsplitter 142 and the tip 106A.

In a specific case, the repositioning of the beamsplitter 142 can be effectuated by flipping the beamsplitter about a chosen rotation point or axis with the use of an appropriate hinge and/or in a hinge-like fashion. In this case, the overlapping between the beams 110 and 144 includes removably inserting the dichroic beamsplitter 142, configured as a hinged component, into an optical path of the beam 110 by rotating said first beamsplitter around a rotation point of a hinge.

Upon traversing the interferometer system 114, light 110 (or a combination of co-axially-aligned beams 110 and 144) is further directed towards a light-focusing element 150 (in one embodiment—a light reflector) that is dimensioned to converge light incident thereon onto an apex of the tip 106A and to collect and collimate portions 154, 158 of the so-converged light returned from the apex upon reflection. The collimated beams 154, 158 are further directed in a direction opposite to the direction of the incoming beam 110 and through the interferometer system 114.

In one implementation, the focusing element 150 has a low spectral dispersion (in one example—not exceeding that of Ge material) and includes a parabolic mirror or, alternatively, a lens with dispersion low enough (for example, |dn/dλ|<0.03 μm⁻¹) to make it operably acceptable for focusing of the broadband light from the source(s) 168, 120. It is understood that the short focal length may be preferred in one implementation. In one implementation, the element 150 includes an Au or Ag or Al off-axis 90 degree parabolic mirror with the focal length of about f₁₅₀=25 mm. A reflector formed with the use of the Ag or Al coating mirror has minimal (if any) absorption in the visible spectrum (as compared to the Au coating). Such characteristic is beneficial when using the inspection optics unit 160 that is utilized in the visible portion of the spectrum.

It is appreciated that the focal lengths of the element 134 and the element 150, aggregately with the spatial dimension(s) of the spatial filter 138 determines the spot size of light on the tip 106A. It is preferred that the opto-geometrical characteristics of the elements 134, 138, 150 be chosen to define the spot size to be equal to or smaller than the size of the tip 106A itself.

When present, the visible beam 158 may be additionally and optionally directed towards the optical inspection unit 160 by the beamsplitters 118 and 162. The unit 160, schematically outlined in FIG. 1 with an elliptical dot-dashed line, is configured to facilitate the determination of a degree of overlap of a) the visible beam 144 (when present) or b) the visible component of the beam 110 with the apex tip 106A. The optional inspection unit 160 includes an optical detector 164 and an optical element 166 configured to converge light 158 at the detector 164 and operating either in transmission (for example, a lens) or in reflection (for example, a mirror). The unit 160 may additionally include a source168 of broadband (for example, white) light and an (optionally repositionable, for example flappable over a rotation point) beamsplitter 170. In one extreme position, the beamsplitter 170 is oriented to guide the broad-band light output 172 from the source 160 towards the tip apex 106A to illuminate the apex. The reflected portion of the beam 172 by the apex 106A is also collected by the focusing element 150 and returned to the detector 164 through the interferometer system 114. The image of the tip 106A in light 172 is then detected with a CCD 164 to ensure that the visible light beam(s) 144 and/or 158 (and, optionally, the visible component—if present—of the light output 110) are delivered to the tip 106A to overlap with the tip in an optimal fashion and that the imaging of light output 110 from the source 120 onto the tip 106A is effectuated without astigmatism, as further referred to below.

It is appreciated that, generally, beamsplitter 170 is partially transparent (for example, at a level of about 50%) at the wavelengths of the alignment beam 158 (when present) and/or at the wavelengths of the visible portion of the light output 110. In one implementation, the focusing element 166 includes a plano-convex BK7 lens with an approximately 300 mm focal distance f₁₆₆. The sensitive element of the detector 164 is disposed in the focal plane of the element 166. In a specific case, when the beamsplitter is configured to substantially fully transmit IR light, the beamsplitter 162 may be defined as a stationary optical component. In a related embodiment, the inspection unit 160 may be absent from the system 100. Notably, the optics of the system is such that the CCD 164 is not in optical communication with the mirror 182 and, therefore, is not in optical communication with the reference arm of the interferometer 114 via any of the beams of light present in the system during its operation.

The inspection optics 160 is also configured to align the optical axis of the off-axis focusing element 150 to be collinear with the IR beam 110 incoming thereto from the element 118. (Generally, an off-axis parabolic mirror is a segment of a full paraboloid with a—often, circular—cross-sectional aperture. An off-axis parabolic mirror is a reflecting mirror with the focal point of which is defined to be offset from the optical path of the beam. Often, the optical axis is folded and displaced from the mechanical axis, providing unobstructed access to the reflecting surface of such mirror. For example, in a 90 degree off-axis parabolic mirror the beam is reflected at an angle of 90 degree at the parabolic-shaped surface with respect to the incident direction of the beam. Off-axis mirror provides an advantage of low—if any—dispersion as compared to lenses and, in comparison with on-axis focusing mirrors, do not block the incoming beam by the object at the focus of the mirror (such as the AFM tip 106A). Advantageously, a parabolic mirror has only one focal spot and only light that is traveling parallel to the optical axis of the mirror is reflected into this single focal point. Light that is not collinear with the optical axis shows astigmatism at the approximate focus, resulting in reduced and/or poor focusing efficiency and poor imaging quality).

Such configuration may be required to achieve a high-quality (for example, with minimized optical aberration) imaging of the intermediate image A onto the tip 106A. To achieve the required optical alignment, a following simplified procedure can be employed: a diffuse scatterer (such as a paper card) is positioned in the vicinity of the focal point of the element 150 to be illuminated with the converged visible light (the beam 144 or the visible component of the beam 110). The image of the diffuse scatterer on the CCD 164 is optimized to obtain a round distribution of light at the focus of the element 150 without astigmatism by, for example, adjusting either the beamsplitter 118 and/or an additional reflector (not shown) disposed in between elements 118 and 150. In one specific case, the method for alignment of the near-field optical system of the invention includes, therefore, steps of (i) overlapping a first beam of infrared (IR) light output 110, produced by a laser-driven plasma source of light 120, with a second beam of visible light 144 (for example, with the use of a first dichroic beamsplitter 142); optionally, only the visible light portion in light output 110 may be used for the following alignment procedure, i.e. without utilizing a second beam of visible light 144; (ii) reflecting light, which is contained in so overlapped first and second beams of light and which has interacted with an off-axis light-focusing optical element 150 disposed in a sample arm of an interferometer unit 114 of the near-field system, at a focal spot of said off-axis light-focusing optical element to form a return optically-diffused beam of light (for example, beam(s) 158 and 154, or only 154) and to propagate such return optically-diffused beam of light through the sample arm towards the first beamsplitter. In addition, the method for alignment may include the step of adjusting at least one of orientation and position of the off-axis optical element 150 to define an image of the focal spot, formed (for example, at the optical detector 164) in light of the return optically-diffused beam of light that has propagated through the sample arm, until such image indicate absence of astigmatism caused by orientation and/or position of the element 150.

In one specific case, the dimension of the image of the 100-to-150 microns diameter pinhole (used in the component 138) formed at the tip 106A is reduced by factor of 4. The so dimensioned image, while still possibly larger in size that than the tip 106A, may be operably acceptable because of the tradeoff between the image quality and power of light transmitted through the pinhole. In one implementation, a smaller pinhole with the diameter of about 25 microns is used with a demagnification factor of about 1 to 2, to reduce the spot size on the tip to about 12.5 to 25 microns, thereby, matching the tip's spatial size more closely.

In one implementation, the beam combiner 142 is configured to filter out the UV+VIS light that otherwise could (i) damage the tip 106A and/or sample 102 and/or the detector 180 (disposed in one of the arms of the interferometer) and (ii) increase noise on the detector 180. The filter could also be optimized for maximum transmission in the spectral region of interest (here IR), while reflecting at least some light of the HeNe laser for alignment.

As was already mentioned above, as an alternative to the use of the beam of visible light 144, a visible portion of the light 110 from the thermal source 120 (delivered from the output of the light source portion 104) can be used for the IR light alignment with the tip 106A.

Spatial alignment of the probe 106A with the focus of the IR beam 110 after mirror 150 usually presents a practical difficulty in operating the s-SNOM system. One known solution comprises a 3-dimensional, spatial scan of the light-focusing element 150 while the search for useful near-field information containing IR-tip-scattered optical signal, recordation and maximization of such signal is taking place. Such method is time-consuming and rather random and relies also on an already-aligned detector to measure the tip-scattering. As an alternative, an alignment visible-light-output laser 148 in combination with a beamsplitter 142 can be used (as is done to combine light outputs from the IR laser sources such as QCLs or CO2 lasers). In contrast with conventional situations known in related art, and while the similar use of the alignment laser 148 can be employed in the s-SNOM system, the output from the plasma light source does not have to be aligned collinearly with the output from an alignment laser, thereby saving both time and complexity of the alignment system. Indeed, a portion of the radiant output from the plasma source itself includes visible light the beam of which that is intrinsically already collinear with the IR portion of such radiant output. In practice, the spatial alignment first requires that the mirror 150 is aligned with its optical axis parallel to the incoming IR beam 110 to minimize astigmatism (as discussed above). It is understood that element 150 can be an off-axis parabolic mirror, or another focusing element such as a lens. The next step is to align the tip with the focus spot of the beam 110 formed by the element 150. For that purpose the auxiliary tip-inspection optics (not shown) of the AFM of the s-SNOM system located above the tip (and normally used to show the sample position with respect to the cantilever 106B, or to align the AFM deflection laser onto the cantilever 106B) can be employed. With the use of the tip-inspection optics, the tip position under the cantilever can be typically determined with the 10 to 20 micron accuracy. When the tip is in contact with a suitable reference sample (e.g. a sample that scatters visible light diffusely), the mirror 150 can be scanned in 3D and the visible portion of the radiant output from the plasma source, focused by the element 150, can be seen in the top-down tip-inspection optics due to light scattering from the surface of the SUT. A suitable algorithm (such as pattern-recognition algorithm) may be used to minimize the focus diameter or maximize the localized, scattered light intensity on the sample surface while the tip is in contact with the sample. After this step, the situation is achieved when the focus spot of light delivered by the element 150 towards the tip lies in the sample plane. The following spatial translation of the element 150 is then used to move the visible spot (together with the IR spot) towards the spatial location of the tip. Due to the collinearity between the visible light and the IR light outputs from the plasma source and the substantially equal focal lengths at these wavelengths (in the absence of dispersive elements in the system), the IR spot is aligned to the tip position within at least 10 to 20 micron accuracy. Given that the spectral range of interest is from about 2 microns to about 12 microns, and that a diffraction-limited spotsize is at least ½ of the wavelength of interest, a further fine adjustment of the element 150 in 3D facilitates a quick optimization of the spatial overlap of the IR portion of the beam 110 delivered from the element 150—to the tip and the tip itself.

In a related embodiment, the element 150 may be kept stationary. In such a case, the above-identified optimization steps are effectuated by moving the combination of the tip and sample, as a whole, in 3D instead of moving the element 150.

In yet another implementation of the alignment procedure, the reference sample is removed. A coarse 3-dimensional scan of the element 150 shows scattering off the top of the cantilever 106B itself when the visible light portion of the plasma source radiant output is incident on the cantilever. At that point, only the focus position needs to be minimized (which minimization is observed as increase in scattering originating from a smaller spot on the cantilever top surface). The cantilever width is typically 5-50 microns (while its length typically exceeds 50 microns), and since the visible focus spot typically has only a few microns in diameter, it fits within the geometrical bounds of the cantilever and can be seen easily. To increase the degree of light scattering, the cantilever top surface may be treated to increase its roughness. Such treatment may involve etching of the surface for roughening or the structuring to provide spatial scatterers for the visible light of interest. In the next step the focus is then brought via translation of the element 150 to the end of the cantilever, such that the tip is located within typically 10 to 20 microns. This alternative alignment procedure facilitates the alignment of the IR portion of the beam 110 to within 10 to 20 microns with respect to the spatial position of the tip. After going into contact with the sample of interest, the s-SNOM signal can be fine-tuned by, for example, automatic fine-adjustment of the position and/or orientation of the element 150 in 3D.

Interferometer System.

Referring again to FIG. 1, the light output 110 from the light source portion 104 is further directed to the interferometer system 114 (as shown—a Michelson-type interferometer), the IR beamsplitter 118 and the movable mirror 182 of which define the reference arm, while the beamsplitter 118 and the tip 106A define the sample arm. The optical path between the elements 118, 182 is chosen to be as close as possible to the optical path between the elements 118 and 106A. In one case, the beamsplitter 118 contains a CaF₂ substrate AR-coated for a broad-band performance with a 50:50 reflection-to-transmission ratio. In other implementations the beamsplitter is ZnSe, KBr or KRS-5, common materials for high-quality infrared beamsplitters in (far-field) Fourier-Transform IR (FTIR) spectrometers.

The interferometer system 114 is equipped with a low-noise infrared detector 180 (in one scenario—an InSb detector with 100 microns by 100 microns detector element). InSb material cuts off light at wavelengths longer than about 5 microns, and is accordingly ill suited to detect infrared light at wavelengths exceeding 5 microns. In order to cover a broad infrared spectrum, another detector may be employed (such as an MCT detector) for light detection in the range between about 2 microns and about 12 microns; preferably—between about 3 micron and 16 microns; more preferably—between about 2 microns and 26 microns, depending on the exact material composition of the detector element. It is recognized that the longer the cutoff wavelength the higher is the noise level associated with the detector. Accordingly, a tradeoff is required between the output of the source 120 (in terms of the longest wavelength) and the detector cutoff wavelength. Other practical variations may include the size of the detector element (which could for instance be a 200×200 micron squared element).

To optimize the signal-to-noise ratio, it is preferred that the sensitive element of the detector 180 has the same dimensions as those of the spot size of the tip-scattered IR beam coming from tip 106A for optimal signal to noise so that the detector 180 is neither over- nor under-filled by the tip-scattered light. It is preferred that the reference light reflected off the element 182 has an equally large spotsize on the detector for optimal signal to noise in the interference signal. The detector may act as a spatial filter itself if the reference light spot size is larger than the detector element. In order to match the spot size to the detector area, the focusing element 186 can be chosen to have a larger focal length to form a larger focal spot at the detector 180. It is appreciated, however, that a smaller-area detector is preferred because the noise level increases with the increase of the area of the detector.

The mirror 182 can be made partially transmissive, in one case, to acquire light from the interferometer 114 through the mirror 182 with a dedicated detector system (not shown) for the purpose of determination of light intensity characteristics. Such detector system can be operably connected with the system-operation governing electronic circuitry (which is discussed below). The light intensity can be monitored here or directly at the source 120 to stabilize the IR output power with a feedback loop that adjusts the pump laser power or the gas pressure or the pump laser frequency to maintain a constant output power for minimizing noise (not shown in Figures).

Sample(s) and the Tip.

In one embodiment, the tip of the AFM is configured as a reflector which, in operation, is positioned over the surface of the moving sample under test (and, in one case, the sample is moving in a recurring or reiterative fashion with respect to the tip). The operation of the AFM (including that of the cantilever and tips 106A, 106B) is optionally governed with a programmable processor, as part of the application circuitry discussed below.

Sample under test (or sample of interest) and the reference sample can be used. The reference sample can be a sample different from the sample of interest or, alternatively, an area on the sample of interest that is non-absorbing with a spectrally flat response in the spectral region of interest and that is spatially separated from the target area of the sample of interest. Each of the sample of interest and the reference sample generally have to be measured at the same optical alignment of the near-field apparatus described in FIG. 1 to allow for correct comparison between the acquired respectively-corresponding target and reference spectra. For that purpose, the tip 106A is kept at a fixed location between sample measurements, while the sample stage and/or scanner (not shown) are used to translate the sample(s) under the tip 106A. This prevents the situation where the alignment of the tip with respect to the IR beam is lost, in which undesired situation the acquisition of the near-field signals from which the nanoscale absorption and/or reflection of light at the tip 106A is hindered.

The target (of interest) sample and reference sample do not have to be positioned on the same stage at the same time. The reference sample can be inserted before or after the sample measurement as long as sample and reference are measured for the same optical alignment. To obtain nanoscale absorption/reflection data the near-field signal on the sample of interest has to be normalized to a reference sample that is non-absorbing in the spectral region of interest, e.g. Si.

Electronic Circuitry.

The system 110 is additionally equipped with the controller 184 that contains a programmable processor and tangible, non-transitory storage medium containing program code thereon. When programmed with this code, the controller is configured to translate the sample 102 to the desired position under the tip 106A, to govern the operation of the detector 180, to acquire from the detector 180 optical data representing position-dependent near-field absorption and/or reflection spectra of the sample 102, and to create visually-perceivable representation of at least one of such spectra (in the form of plots, for example) on the display unit 188.

Notably, the system 100 is configured to operate in at least two modes.

Mode I:

when the spectral filter system 128 is absent (or when such system is simply not in use), the resulting configuration simultaneously employs light from broadband light source at multiple frequency components. The operation is carried out by scanning the optical path difference between the reference arm and the sample arm in the interferometer, which can be done by either scanning the position of the reference mirror perpendicular to the light direction or shifting the sample position (including the tip and while maintaining the same position of the tip with respect to the sample) perpendicular to the direction in which light propagates. The signal from the detector vs. the optical path difference of the reference arm and sample arm are simultaneously recorded and used in the following data analysis to obtain information about the sample.

This mode may require an additional optical element to be inserted in the element in the beam path (for example, namely a compensator plate in one of the arms of the interferometer; either between elements 118, 182 or between elements 118, 150 to compensate the dispersion introduced into the other arm of the interferometer 114 by the beamsplitter 118 itself. In such a case, the compensator plate can be made of the same material and have the same thickness as the beamsplitter 118, to exactly cancel the dispersive influence of the beamsplitter 118.

The mirror 118 is moved in steps to acquire a read-out data on the detector 180. Around the whitelight position (defined at a point when the two arms of the interferometer have equal optical lengths), the detector 180 acquired optical data representing an interferogram. With the use of a Fourier transformation algorithm, a complex frequency-dependent spectrum s(ω)exp(iφ(ω)) is obtained that is normalized by the complex reference spectrum s_{ref}(ω)exp(iφ_{ref}(ω)), obtained with the use of a non-absorbing reference sample (such as a piece of Si or Au, for example). The imaginary part of the resulting normalized spectrum is a good approximation for the sought-after absorption of the target sample in terms of spectral positions of the absorption lines, line widths, and relative strengths of the absorption lines, valid for weak oscillators useful to describe, for example, most polymer materials. Weak oscillators have a strictly positive real part of the dielectric constant in the region where they resonantly absorb. The real part of the normalized spectrum is dispersive and approximately linearly proportional to the reflection of the sample. In general, the complex dielectric function of the sample can be obtained by modeling when the near-field spectrum of the sample is normalized to a spectrum from a reference sample of known dielectric function.

Mode II:

When the spectral system 128 is present in the system 100, light 110 at the output P is substantially monochromatic, spatially coherent light that can be used for the two phase homodyne detection. Here, the output data from the detector 180 is read at two positions of the mirror 182 for two-phase homodyne detection at discrete frequencies. From the two measurement results acquired at interferometer mirror positions that are different by λ/8 (resulting in a phase difference of π/2 between the two interferometer arms), the complex value of near-field can be obtained. To extract absorption/reflection data normalization on a non-absorbing reference sample is required. To obtain an extended absorption/reflection spectrum for multiple wavelengths, the procedure of signal acquisition and normalization is repeated.

Assuming that the spectral filter system 128 (such as the monochromator) can repeatedly be tuned to the exact same wavelength with exact the same output beam properties (in term of spatial position, direction of propagation, beam profile, beam diameter, and power, for example) the spectrum characterizing the target sample can be acquired step-wise over the entire spectral range of interest. After that, the measurement is repeated at the very same wavelengths but this time with the use of a reference sample. The step-size between the wavelengths determines the desired wavelength resolution of the measurement. If the monochromator output is not repeatable, on the other hand, the reference sample has to be measured before or after the sample of interest is measured, during the time-window when the optical alignment and especially the monochromator output is not changed between sample and reference measurement. Such “calibration procedure” ensures that sample and reference near-field data is obtained at the exact same frequency under the exact same optical alignment conditions so that absorption/reflection data can be calculated.

According to the implementation of the idea of the measurement, final near-field absorption spectrum for material identification is acquired at certain positions of the sample. The near-field spectrum can be taken at a single, discrete spot on the sample to identify the material at this location. Alternatively, spatial scans on the sample surface in 1 or 2 dimensions can be carried out while a spectrum is acquired at each position, in order to obtain a map of the spatial distribution of a certain material. Distances between the locations of the measurement are determined by the specifics of the sample itself, the application, length scale of the inhomogeneity of the material(s) of the sample, and acquisition time considerations, but typically range from about 1 nm to 100 microns.

Embodiments of the invention—either system and/or method—have been described as employing a processor controlled by instructions stored in a memory. The memory may be random access memory (RAM), read-only memory (ROM), flash memory or any other memory, or combination thereof, suitable for storing control software or other instructions and data. Some of the functions performed by the processor to effectuate the steps of the method of the invention have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein.

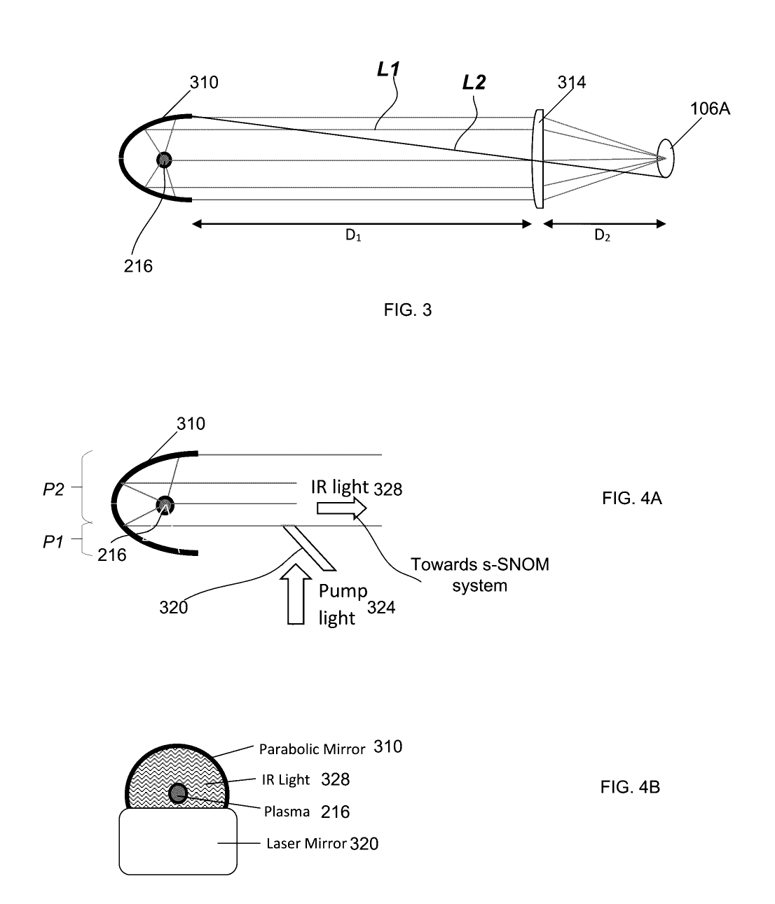

For example, a problem of spatial mismatch between the size of the tip 106A of the system and the image of the light distribution of the source of light 120 formed on the tip can be addressed, for example, in an embodiment utilizing a parabolic reflector 310 in proximity to the plasma 216, configured to collect the emitted light, and a lens element 314 configured to focus the so-collected light into the tip 106A. The schematic diagram of the proposed solution (which diagram, for simplicity of illustration, is devoid of most of the features and elements and components of the embodiment of the system 100) is shown in FIG. 3.

Here, the focusing lens 314 is disposed to project light received from the collection mirror 310 onto a (virtual) image plane at the SPM tip. Light L1 from the collection mirror traveling parallel to the optical axis are projected onto the center of the image—where the tip resides. Light L2 travelling at an angle to the optical axis (and corresponding to the chief ray, in geometrical limit) is projected off-center. The maximum size of the image equals the diameter of the collection mirror reduced/amplified by the ratio of the image distance to the object distance (D₂/D₁) as shown in the image. In that sense, the collection lens/mirror acts as a limiting aperture. By choosing D₁, one may control the size of the illuminated area at the tip 106A. The selected value of D₁ provides a trade-off that depends—among other things—on the size and shape of the particular SPM tip.

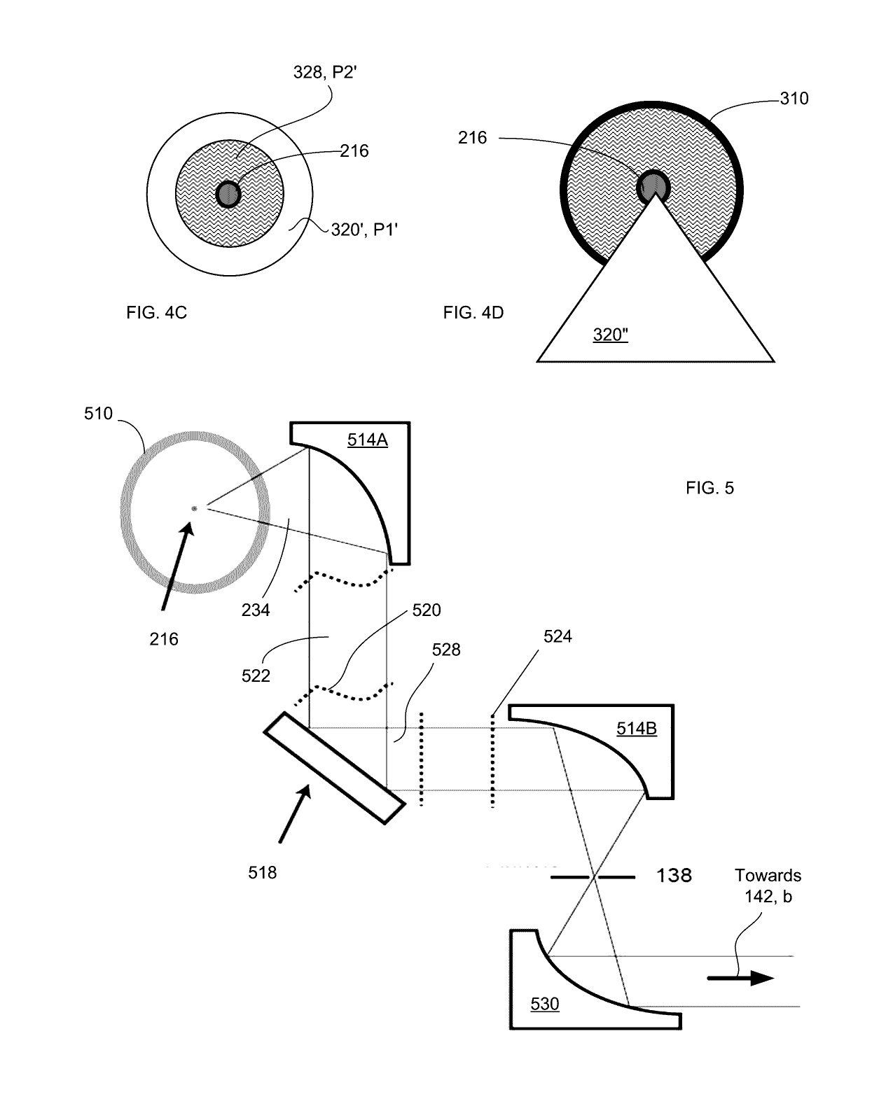

In another related embodiment, referred to schematically in FIGS. 4A, 4B, the source is modified to include the parabolic IR-reflector 310 and complemented with a reflector 320 configured for reflection of the pump light 324, delivered from the outside of the plasma source. FIG. 4A shows the side view of the diagram, while FIG. 4B presents the front view of the same. The positioning of the reflector 320 is quite distinguished from what would be considered conventional in related art. Specifically, in related art the reflector performing the function of reflection of the pump light towards the plasma emitter is semi-transparent and is disposed at a non-zero angle with respect to the optical axis such as to deliver the pump light to the full clear aperture of the plasma source. In such conventional configuration, the IR light 328 generated by the so-excited plasma has to pass through the semi-transparent reflector which is, accordingly, designed to reflect the light at the wavelength(s) of the pump light and to transmit light at the wavelength(s) of the useful IR output from the plasma source. This increases the cost of the semi-transparent reflector and/or causes unnecessary optical power losses, reducing the useful IR output from the plasma source. In the proposed modification (as per FIGS. 4A, 4B), the reflector 320 does not have to be configured as a spectrally-selective beamsplitter component but, instead, is a simple reflector operating at wavelengths of the pump light, while a “lower” portion P1 of the clear aperture of the mirror 310 is utilized for collection of pump-light 324 and the “upper” portion P2 of the clear aperture of the mirror 310 is used for collection and delivery towards the s-SNOM system of the useful IR light output 328

FIGS. 4C, 4D illustrate schematically modifications of the implementation of the partial-clear-aperture pump-light delivery idea of the invention. As shown in FIG. 4C, the pump-light reflector 320′ is configured as closed oval reflecting band disposed at a non-zero angle (that is, inclined) with respect to the optical axis, the projection of which band viewed along the optical axis is an annulus, as shown. The reflecting band 320′ accepts and delivers into the clear aperture of the mirror 310 the pump light 324 in a portion P1′ of the clear aperture that is configured as a annular peripheral region of the clear aperture of the mirror 310 and is substantially co-axial with the optical axis of the reflector 310, while the IR light 328 generated at the plasma emitter 216 is collected by the central portion P2′ of the reflector 310, which is circumscribed by such annular region P1′. FIG. 4D presents a diagram of yet another modification of the pump-light delivery train of optical components, in which the reflector 320″ is configured to have a polygonally-shaped perimeter. In each of embodiments of FIGS. 4A, 4B, 4C, and 4D or similar embodiments, the operational advantage is taken by a) spatially-separating the portions of the clear aperture of the mirror 310 through which the pump light is delivered towards the plasma and through which the IR light output generated by the plasma is output towards the s-SNOM system, and b) making a reflector 320, 320′, 320″ to be a simple reflector and not spectrally-selective beamsplitter.

Yet another related embodiment is envisioned that is configured to improve the quality of the IR-light wavefront, emanating from the source 120, with the use of an adaptive-optics system. In reference to the schematic diagram of FIG. 5, when the IR-light-transmitting light bulb 510 is used for holding the plasma and gases 216, the optical quality or surface roughness and/or flatness of the optical plasma-encasing element 510 affects the quality of the wavefront of the useful IR-light 234 emanating from the source 120, which, in turn, may reduce the quality of focusing of light 110 on the tip 106A of the s-SNOM system. To compensate and/or improve the quality of light 234, light 234 coming out of the plasma-encasing element is collected with a parabolic mirror 514A (or, alternatively, an IR-light transmitting lens such as lens) that is disposed with its focal point at the location of the plasma emitter 216, and directed to a deformable, pixelated, faceted reflector 518 (the adaptive optical element) the orientation and/or position of individual reflective pixels of which can be appropriately and independently controlled. The presence of the optical encasing element introduce uneven phases to the wave front, to create distortions in the wavefront 520, as schematically illustrated by the dashed lines. The adaptive reflector 518 is controlled, with a programmable computer processor, to introduce the appropriate phase offset(s) at different spatial locations to the cross-section of the incoming beam 522 carrying light 234 such as to improve the quality of and to flatten the wavefront 524 of a beam of light 528 reflected by the reflector 518. A secondary parabolic reflector The values of phase offset(s) to be introduced by the pixels of the deformable reflector 518 to the beam 522 is/are defined with the use of an algorithm structured to achieve the maximization of light throughput through the spatial filter (element 138, as discussed above). Upon transmission of light through the spatial filter 138, the light is further direction to the remaining portion of the system of FIG. 1 (an element of which in one specific case can be formatted or configured as yet another parabolic mirror 530, the focus of which is positioned at the pinhole of the element 138). The net effect is that it improves the energy density at the spatial filter 138, and allows more light of high spatial-coherence to be delivered to the tip 106A.

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. In one specific case, the terms “approximately”, “substantially”, and “about”, when used in reference to a numerical value, represent a range of plus or minus 20% with respect to the specified value, more preferably plus or minus 10%, even more preferably plus or minus 5%, most preferably plus or minus 2% with respect to the specified value. As a non-limiting example, two values being “substantially equal” to one another implies that the difference between the two values may be within the range of +/−20% of the value itself, preferably within the +/−10% range of the value itself, more preferably within the range of +/−5% of the value itself, and even more preferably within the range of +/−2% or less of the value itself.

The use of these terms in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated falls and may vary within a numerical range defined by an experimental measurement error that is typical when using a measurement method accepted in the art for such purposes.

Other specific examples of the meaning of the terms “substantially”, “about”, and/or “approximately” as applied to different practical situations may have been provided elsewhere in this disclosure.

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention. Within this specification, embodiments have been described in a way that enables a clear and concise specification to bet written, but it is intended and will be appreciated that embodiments may be variously combined or separated without parting from the scope of the invention. In particular, it will be appreciated that all features described herein at applicable to all aspects of the invention.

In addition, when the present disclosure describes features of the invention with reference to corresponding drawings (in which like numbers represent the same or similar elements, wherever possible), the depicted structural elements are generally not to scale, and certain components are enlarged relative to the other components for purposes of emphasis and understanding. It is to be understood that no single drawing is intended to support a complete description of all features of the invention. In other words, a given drawing is generally descriptive of only some, and generally not all, features of the invention. A given drawing and an associated portion of the disclosure containing a description referencing such drawing do not, generally, contain all elements of a particular view or all features that can be presented is this view, at least for purposes of simplifying the given drawing and discussion, and directing the discussion to particular elements that are featured in this drawing. A skilled artisan will recognize that the invention may possibly be practiced without one or more of the specific features, elements, components, structures, details, or characteristics, or with the use of other methods, components, materials, and so forth. Therefore, although a particular detail of an embodiment of the invention may not be necessarily shown in each and every drawing describing such embodiment, the presence of this particular detail in the drawing may be implied unless the context of the description requires otherwise. In other instances, well known structures, details, materials, or operations may be not shown in a given drawing or described in detail to avoid obscuring aspects of an embodiment of the invention that are being discussed. Furthermore, the described single features, structures, or characteristics of the invention may be combined in any suitable manner in one or more further embodiments.

The invention as recited in claims appended to this disclosure is intended to be assessed in light of the disclosure as a whole, including features disclosed in prior art to which reference is made.

Disclosed aspects, or portions of these aspects, may be combined in ways not listed above. Accordingly, the invention should not be viewed as being limited to the disclosed embodiment(s)

1. A near-field system for inspection of a sample under test (SUT), the system having an axis and comprising:
a laser-driven plasma source of light configured to generate a first light output, the first light output including IR light and having a first range of spatial frequencies and a first range of spectral frequencies;
a first optical system located to collect the light output at least along the axis and to form a second light output, the second light output having a second range of spatial frequencies and a second range of spectral frequencies, the first and second ranges of spatial frequencies being different from one another;
an optical interferometer system including a reference arm and a sample arm and in optical communication with said plasma source of light through the first optical system, the sample arm terminated by a reflector;
and
an optical detection system disposed in optical communication with said reflector through the optical interferometer system and in optical communication with the reference arm to acquire an optical signal interferometrically formed by
a) first light backscattered by said reflector in response to being illuminated with a portion of said second light output, and
b) second light representing a portion of said second light output that has been phase-delayed with respect to the first light,
wherein the near-field system is configured to provide a relative movement between the SUT and the reflector.

2. A near-field system according to claim 1, further comprising a second optical system disposed across the axis and configured to change spectral content of light incident thereon from the first optical system to form a third light output having a third range of spectral frequencies and a third range of spatial frequencies, the second and third ranges of spectral frequencies being different from one another.

3. A near field system according to claim 2, wherein a component of the second optical system is part of the sample arm, and wherein the portion of said second light output illuminating said reflector is said third light output.

4. A near-field system according to claim 2, wherein a combination of the first and second optical systems is configured to form an image, of a plasma distribution of said plasma source of light, at a tip of an atomic force microscope (AFM) of the system, said image being substantially co-extensive with said tip.

5. A near-field system according to claim 1, wherein the sample arm is terminated by a tip of an atomic force microscope (AFM) of the system.

6. A near-field system according to claim 1, further configured to deliver a beam of visible light through the interferometer to said reflector and collect a portion of said visible light at an optical detector that is not in optical communication with the reference arm.

7. A near-field system according to claim 1, wherein the first optical system includes a sequence of a pin-hole and a lens element at a focal point of which said pin-hole is disposed, and wherein the first and second ranges of spectral frequencies are substantially equal to one another.

8. A near-field system according to claim 1, wherein the first and second ranges of spectral frequencies are different from one another.

9. A near-field system according to claim 1, wherein said near-field system is configured to provide for a change in a length of the sample arm while keeping a length of the reference arm constant.

10. A near-filed system according to claim 9, wherein said change of the length of the sample arm includes a repositioning of a combination of i) the reflector, ii) the SUT, and iii) an element that is configured to focus light onto the reflector and that is contained in the sample arm, with respect to a beamsplitter of the optical interferometer system.

11. A method for spatially-aligning a near-field system having an axis, the method comprising:
overlapping a first beam of infrared (IR) light output, produced by a laser-driven plasma source of light, with a second beam of visible light with the use of a first dichroic beamsplitter;
reflecting light, which is contained in so overlapped first and second beams of light and which has interacted with an off-axis light-focusing optical element disposed in a sample arm of an interferometer unit of the near-field system, at a focal spot of said off-axis light-focusing optical element to form a return optically-diffused beam of light and to propagate said return optically-diffused beam of light through said sample arm towards the first beamsplitter;
and
adjusting at least one of orientation and position of said off-axis optical element to form an adjusted focal spot of said off-axis light-focusing optical element, wherein said adjusted focal spot is free from astigmatism, thereby defining a substantially free from astigmatism near-field system.

12. A method according to claim 11, further comprising defining an image of the focal spot of said off-axis light-focusing optical element, formed in light of the return optically-diffused beam of light that has propagated through said sample arm, to indicate, in such image, the absence of astigmatism, wherein the astigmatism is caused by said at least one of orientation and position.

13. A method according to claim 11, further comprising
forming an image at a first optical detector with the use of a light-deviating optical component that is disposed between the first dichroic beamsplitter and a second beamsplitter of said interferometer, wherein the second beamsplitter is disposed to spatially combine portions of the first beam that have propagated through the sample arm and a reference arm of said interferometer unit.

14. A method according to claim 11, further comprising
removing said light-deviating optical component from an optical path of the first and second beams of light during said overlapping; and
inserting said light-deviating optical component across said optical path to achieve said forming.

15. A method according to claim 11, wherein said overlapping includes removably inserting said first dichroic beamsplitter, configured as a hinged component, into an optical path of the first beam by rotating said first beamsplitter around a rotation point of a hinge.

16. A method according to claim 11, wherein said adjusting includes disposing said off-axis light-focusing optical component to define its optical axis to be parallel to a portion of the first beam delivered to the off-axis light-focusing optical component through the sample arm.

17. A method according to claim 11, wherein said adjusting includes imaging of said focal spot, formed at an optically-diffusive surface, in said visible light with the use of an optical imaging system disposed above a cantilever of an AFM of the near-field system.

18. A method according to claim 17, wherein the optically-diffusive surface includes a surface of said cantilever.

19. A method for spatially-aligning a near-field system having an axis, the method comprising:
directing a light output, collected from a laser-driven plasma source of light and containing visible and IR light output components, to interact with an off-axis light-focusing optical element disposed in a sample arm of an interferometer unit of the near-field system;
reflecting a portion of said light output at a focal spot of said off-axis light-focusing optical element to form a return optically-diffused beam of light and to propagate said return optically-diffused beam of light through said sample arm towards an optical detector;
and
adjusting at least one of orientation and position of said off-axis optical element to form an adjusted focal spot of said off-axis light-focusing optical element, wherein said adjusted focal spot is free from astigmatism, thereby defining a substantially free from astigmatism near-field system.

20. A method according to claim 19, further comprising defining an image of the focal spot of said off-axis light-focusing optical element, formed in light of the return optically-diffused beam of light that has propagated through said sample arm, to indicate, in such image, absence of astigmatism caused by said at least one of orientation and position.

21. A method according to claim 19, wherein said adjusting includes imaging of said focal spot, formed at an optically-diffusive surface, in said visible light with the use of an optical imaging system disposed above a cantilever of an AFM of the near-field system.

22. A method according to claim 19, further comprising prior to said adjusting, structurally modifying a top surface of said cantilever to increase a surface roughness thereof.
